(19) United States
(12) Patent Application Publication
(10) Pub. No.: US 2016/0164810 A1
(43) Pub. Date: Jun. 9, 2016

(54) MULTI-ENDPOINT ACTIONABLE NOTIFICATIONS

(71) Applicant: Microsoft Technology Licensing, LLC, Redmond, WA (US)

(72) Inventors: Carl Wolz, Redmond, WA (US); Howard Wolosky, Seattle, WA (US)

(21) Appl. No.: 14/565,100

(22) Filed: Dec. 9, 2014

(51) Int. Cl. H04L 12/58

(52) U.S. Cl. CPC H04L 51/046; H04L 51/24

(57) ABSTRACT

An actionable notification service supports a notification publication and subscription system that interacts with registered endpoints such as smartphones, tablets, and PCs so that notifications can be distributed and effectively managed across multiple endpoints. Applications on registered endpoints can publish notifications into the system to which other registered endpoints may subscribe. The notifications received at the subscribing endpoints are displayed and raised in a manner to be fully actionable so that users can interact with the publishing application as a native experience using either a local handler or by implementing a remote session into the publishing endpoint.

### BACKGROUND

Notifications are typically utilized to provide information to users of devices such as smartphones, tablets, and personal computers (PCs) in real-time to deliver up-to-the-minute news and alerts.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

An actionable notification service supports a notification publication and subscription system that interacts with registered endpoints such as smartphones, tablets, and PCs so that notifications can be distributed and effectively managed across multiple endpoints. Applications on registered endpoints can publish notifications into the system to which other registered endpoints may subscribe. The notifications received at the subscribing endpoints are displayed and raised in a manner to be fully actionable so that users can interact with the publishing application as a native experience using either a local handler or by implementing a remote session into the publishing endpoint.

The actionable notification service is arranged to enable users to efficiently manage notifications received across multiple subscribing endpoints by supporting a user interface (UI) for setting endpoint subscription criteria. For example, a user can elect to accept or suppress notifications to an endpoint at certain times of day, or when the endpoint is on a particular network, or when the endpoint is at a particular location. Also, when a user dismisses a notification raised at one endpoint, the notifications at the other subscribing endpoints can also be dismissed by the actionable notification service to eliminate duplicated and redundant notifications.

Advantageously, the actionable notification service gives endpoint users ways to manage notifications in ways that improve user experiences while also enabling control and optimization of endpoint resource consumption and transmission network utilization. For example, users can interact with the actionable notification service to select subscription criteria to suppress notifications to certain subscribing endpoints under some conditions to reduce resource consumption at those endpoints where battery life and resources would otherwise be expended to power the endpoint radio receiver and light up the screen to display the notification. In other scenarios, users may decide to allocate network usage so that notifications can be raised at subscribing endpoints that are on Wi-Fi networks while notifications are suppressed to other subscribing endpoints that may currently have only connectivity to cellular data networks.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It may be appreciated that the above-described subject matter may be implemented as a computer-controlled apparatus, a computer process, a computing system, or as an article of manufacture such as one or more computer-readable storage media. These and various other features may be apparent from a reading of the following Detailed Description and a review of the associated drawings.

### DESCRIPTION OF THE DRAWINGS

FIG. 1 shows an illustrative environment in which endpoints having communications capabilities interact over one or more networks;

FIG. 2 shows various illustrative access networks that may be utilized by endpoints;

FIG. 3 shows illustrative access network attributes;

FIG. 4 shows an illustrative layered architecture that includes an application layer, operating system (OS) layer, and hardware layer;

FIG. 5 shows application programming interfaces (APIs) exposed by an actionable notifications client and notification generating and handling applications;

FIG. 6 shows an illustrative arrangement in which endpoints are registered with a notification publication and subscription system;

FIG. 7 shows an illustrative example of an actionable notification that is published by a publishing endpoint and received by subscribing endpoints;

FIG. 8 shows an illustrative example of an actionable notification that includes a payload and metadata;

FIG. 9 shows a taxonomy of illustrative inputs that may be used by the actionable notification service to filter notifications to subscribing endpoints;

FIG. 10 shows illustrative features and functions supported by a user interface (UI) to the actionable notification service;

FIG. 11 shows an illustrative example of an actionable notification being shared among multiple subscribing endpoints;

FIG. 12 shows an illustrative example of an actionable notification being shared among some subscribing endpoints while being suppressed at other subscribing endpoints;

FIGS. 13 and 14 show actionable notifications being dismissed across multiple endpoints;

FIG. 15 shows an actionable notification associated with an incoming VoIP (Voice over Internet Protocol) call at an endpoint;

FIG. 16 depicts a screen capture of an illustrative UI displayed on an endpoint that shows an actionable notification;

FIG. 17 depicts an illustrative native application experience that is surfaced on an endpoint after a notification is actioned;

FIG. 18 shows a native application experience that is supported using a remote desktop;

FIGS. 19 and 20 show illustrative actionable notification scenarios;

FIG. 21 shows illustrative interactions among an actionable notifications service, client components on an endpoint, and a content provider;

FIGS. 22, 23, and 24 show illustrative methods that may be performed when implementing the present multi-endpoint actionable notifications;

FIG. 25 is a simplified block diagram of an illustrative computer system such as a personal computer (PC) that may be used in part to implement the present multi-endpoint actionable notifications;

FIG. 26 shows a block diagram of an illustrative system that may be used in part to implement the present multi-endpoint actionable notifications;

FIG. 27 is a block diagram of an illustrative mobile device; and

FIG. 28 is a block diagram of an illustrative multimedia console.

Like reference numerals indicate like elements in the drawings. Elements are not drawn to scale unless otherwise indicated. It is emphasized that the particular UIs displayed in the drawings can vary from what is shown according to the needs of a particular implementation. While UIs are shown in portrait mode in the drawings, the present arrangement may also be implemented using a landscape mode.

### DETAILED DESCRIPTION

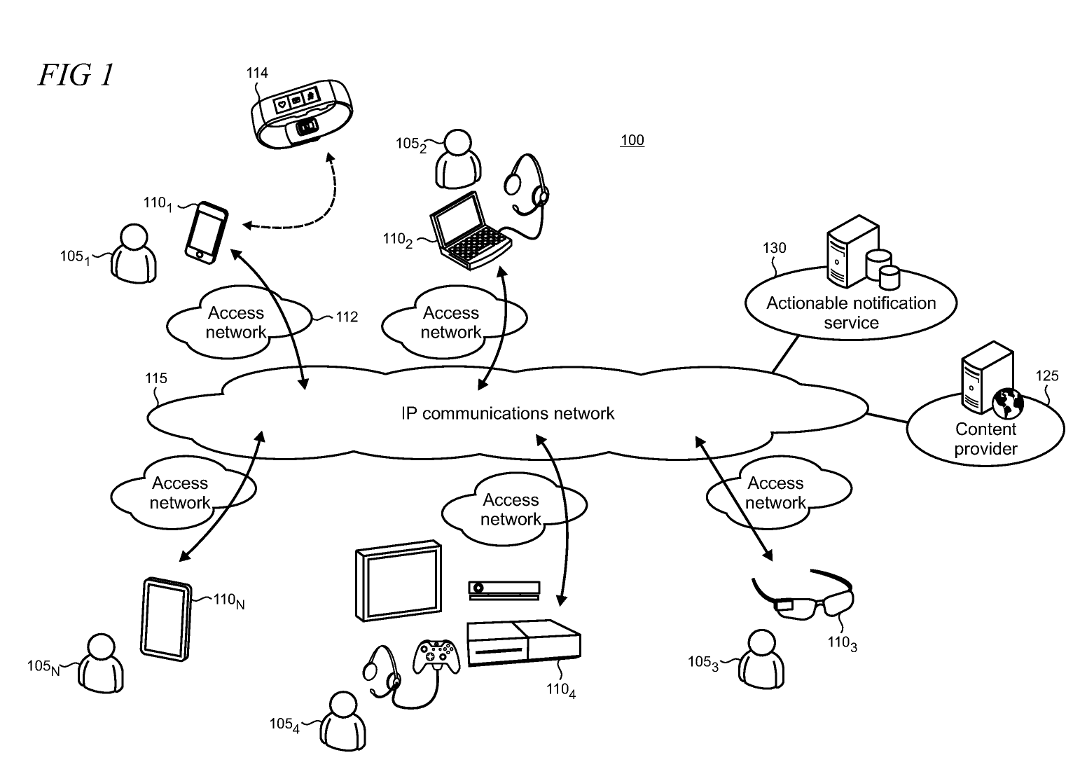

FIG. 1 shows an illustrative communications environment 100 in which various users 105 employ respective devices, termed “endpoints” 110 that can interact over one or more communications networks which can typically include various access networks (representatively indicated by reference numeral 112 and described further below) and an IP (Internet Protocol) communications network 115. The IP communications network 115 typically uses IP-based transport and signaling and can be supported, for example, by mobile operators, enterprises, Internet service providers (ISPs), telephone service providers, data service providers, and the like.

The IP communications network 115 typically includes interfaces that support a connection to the Internet so that the endpoints 110 can access content provided by one or more content providers 125 and access an actionable notifications service 130 in some cases. The endpoints 110 and IP communications network 115 may be configured to enable device-to-device communication using peer-to-peer and/or server-based protocols. Support for device-to-device communications may be provided, at least in part, using various applications that run on an endpoint 110.

The endpoints 110 may provide various capabilities, such as voice and video calling and messaging, and typically support data-consuming applications such as Internet browsing and multimedia (e.g., music, video, etc.) consumption in addition to various other features. The endpoints 110 may include, for example, user equipment, mobile phones, cell phones, feature phones, tablet computers, and smartphones which users often employ to make and receive voice and/or multimedia (i.e., video) calls, engage in messaging (e.g., texting), use applications and access services that employ data, browse the World Wide Web, and the like.

However, alternative types of electronic endpoint devices are also envisioned to be usable within the communications environment 100 so long as they are configured with communication capabilities and can connect to the IP communications network 115. Such alternative endpoints variously include handheld computing devices, PDAs (personal digital assistants), portable media players, phablet devices (i.e., combination smartphone/tablet devices), wearable computers, navigation devices such as GPS (Global Positioning System) systems, laptop PCs (personal computers), desktop computers, multimedia consoles, gaming systems, networked and/or remotely controlled cameras, or the like. Such cameras may include, for example, room and home surveillance cameras, body-worn cameras, webcams, external cameras used with PCs, tablets, and other computing devices, remote cameras in vehicles, etc. In the discussion that follows, the use of the term “endpoint” is intended to cover all devices that are configured with communication capabilities and have IP access capabilities to the IP communications network 115.

The various endpoints 110 in the environment 100 can support different features, functionalities, and capabilities (here referred to generally as “features”). Some of the features supported on a given endpoint can be similar to those supported on others, while other features may be unique to a given endpoint. The degree of overlap and/or distinctiveness among features supported on the various endpoints 110 can vary by implementation. For example, some endpoints 110 can support touch controls, gesture recognition, natural language interfaces, and voice commands, while others may enable a more limited UI. Some endpoints may support video consumption and Internet browsing, while other devices may support more limited media handling and network interface features.

Accessory devices 114, such as wristbands and other wearable devices may also be present in the environment 100. Such accessory device 114 typically is adapted to interoperate with a device 110 using communication protocols like Bluetooth® and USB (Universal Serial Bus) to support functions such as monitoring of the wearer's physiology (e.g., heart rate, steps taken, calories burned, etc.) and environmental conditions (temperature, humidity, ultra-violet (UV) levels, etc.), and surfacing notifications from the coupled device 110.

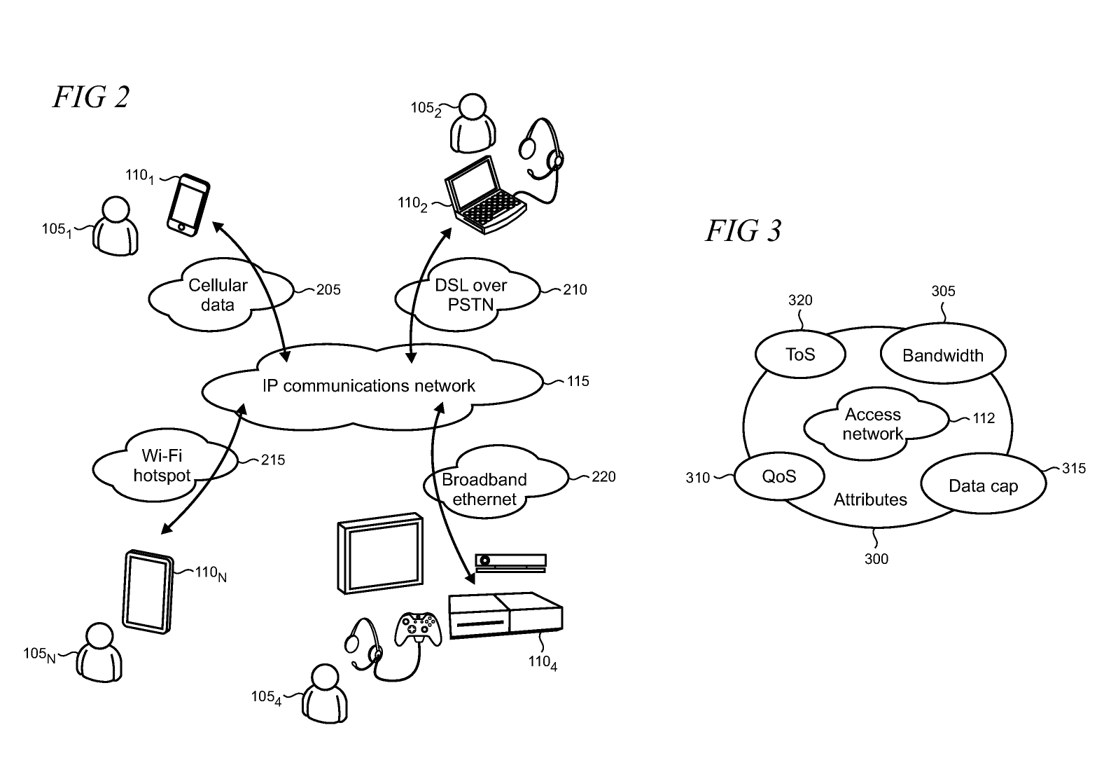

FIG. 2 illustratively shows how different endpoints can use different access networks. In this example, one of the endpoints 110 uses a cellular data access network 205 that may be supported by a mobile operator. A second endpoint 110 employs an access network 210 that uses DSL (Digital Subscriber Line) over PSTN (Public Switched Telephone Network) infrastructure to implement network connectivity to the IP communications network 115. A third endpoint 110 uses public Wi-Fi hotspot as its access network 215 while a fourth endpoint 110 uses an access network 220 provided by an ISP that features broadband Ethernet. It is emphasized that the access network types described here are intended to be illustrative and that various other network types (e.g., satellite, short-range, White Space, etc., may also be utilized to meet the needs of a particular implementation). Additionally in some cases, a given endpoint may be able to establish connectivity with more than one access network. For example, a smartphone may have capabilities to use either Wi-Fi or cellular data in some situations.

Different access networks can have different and varying attributes. For example, as shown in FIG. 3, a given access network 112 typically has associated attributes 300 such as bandwidth 305 which can vary by access network where some networks are typically faster (e.g., broadband Ethernet) and others (e.g., DSL) are slower. Quality of Service (QoS) 310 is another attribute which can vary by access network in which some access networks will guarantee a certain level of performance and/or availability/reliability while others may provide service with no guarantee. Some access networks, such as those associated with mobile data plans can have variable data rates and/or caps 315 where bandwidth may be throttled once a monthly data limit is reached. Terms of service 320 covering aspects such as economic costs, roaming network utilization, data sharing among endpoints, and the like, is another access network attribute that can vary by network and endpoint.

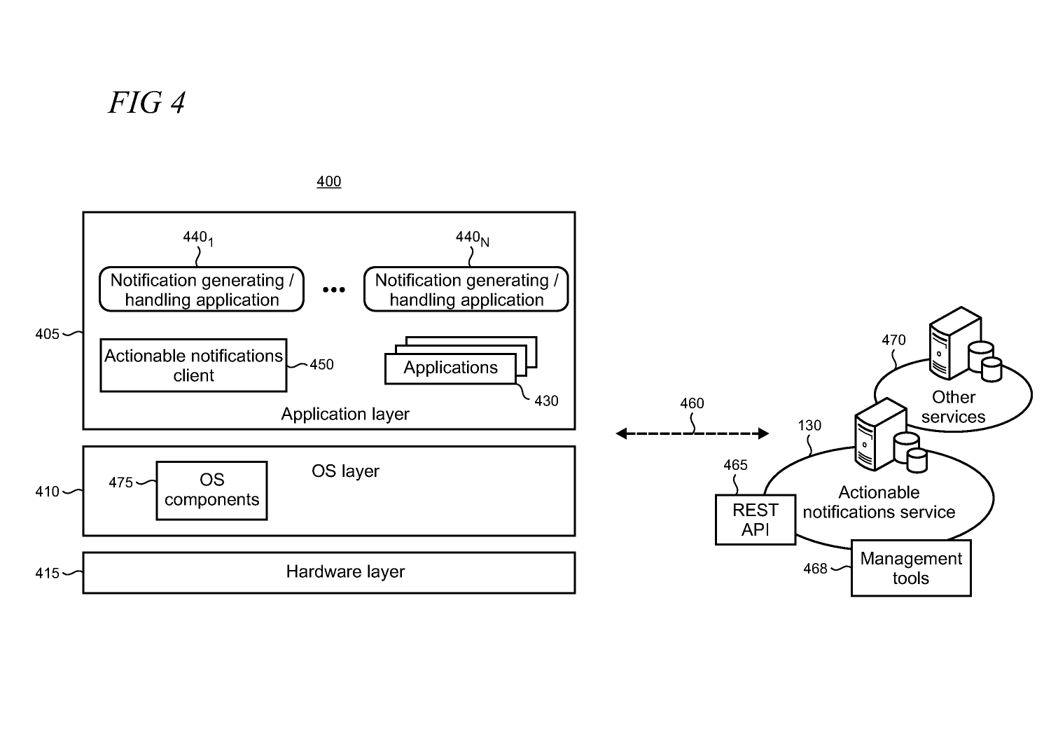

Multi-point actionable notification experiences may be implemented using components that are instantiated on a given endpoint 110. FIG. 4 shows an illustrative layered architecture 400 that supports various applications and other components. The architecture 400 is typically implemented in software, although combinations of software, firmware, and/or hardware may also be utilized in some cases. The architecture 400 is arranged in layers and includes an application layer 405, an OS (operating system) layer 410, and a hardware layer 415. The hardware layer 415 provides an abstraction of the various hardware used by the endpoint 110 (e.g., input and output devices, networking and/or radio hardware, etc.) to the layers above it.

The application layer 405 in this illustrative example supports typical applications 430 (e.g., web browser, music player, email application, etc.), as well as specific applications 440 that can generate and/or handle notifications. An actionable notifications client 450 is also instantiated in the application layer 405 in this example. The client 450 typically is configured to interact with the service 130 to implement an actionable notification system, as indicated by line 460.

In some implementations, the actionable notifications service 130 can expose an API (application programming interface), such as a REST (Representational State Transfer) API 465 so that the notification applications 440 can interact directly with the service 130. Accordingly, the client 450 may not need to be installed in some cases or can serve to supplement methods and functions exposed by the API 465. It is noted that the notification applications 440 can include client components that interact with notification push service/systems which can operate using different protocols (e.g., HTTP (HyperText Transfer Protocol), SMS (Short Message Service), SMTP (Simple Mail Transfer Protocol), etc.) over various network types including, for example, cellular, short-range (e.g., Bluetooth, etc.), IP-based including Wi-Fi and Ethernet, public-switched, and the like.

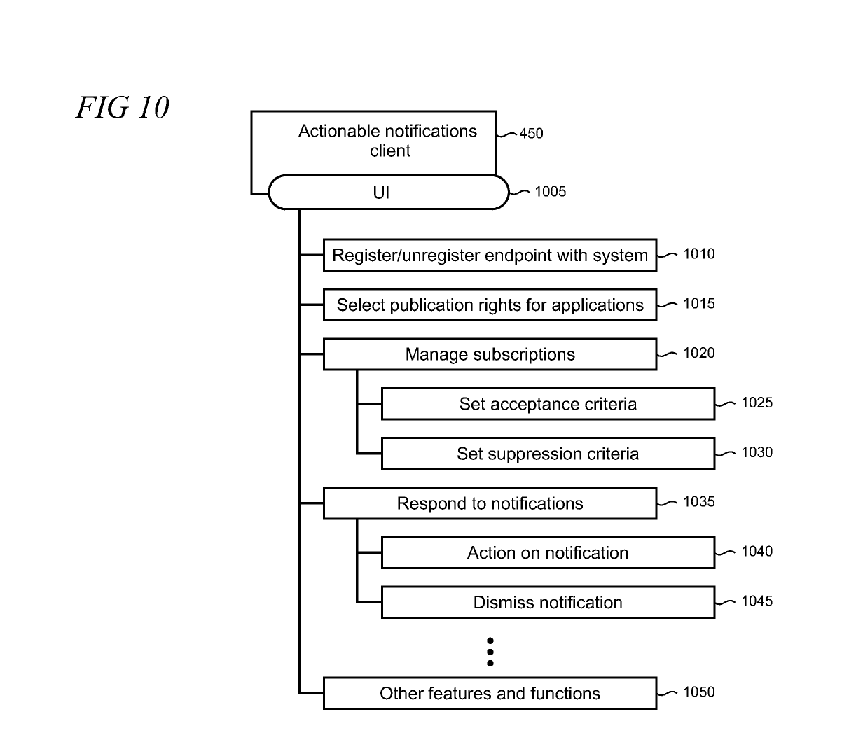

The actionable notifications service 130 may expose management tools 468 in some implementations. The tools 468 may be configured for access using web applications such as a browser to enable users to manage registered endpoints remotely. For example, a user may wish to re-authenticate an endpoint in scenarios in which a device is lost/stolen, or replaced/upgraded. The tools 468 can be used to supplement or replace some of the user interface controls exposed locally on the endpoints as described below in the text accompanying FIG. 10.

The applications 430, 440, and 450 are often implemented using locally executing code. However in some cases these applications may rely on services and/or remote code execution provided by remote servers or other computing platforms such as those supported by other cloud-based resources/services 470. While the actionable notifications client 450 is shown here as a component that is instantiated in the application layer 405, it may be appreciated that the functionality that it supports may be implemented, in whole or part, using OS components 475 and/or other components that are supported in the hardware layer 415.

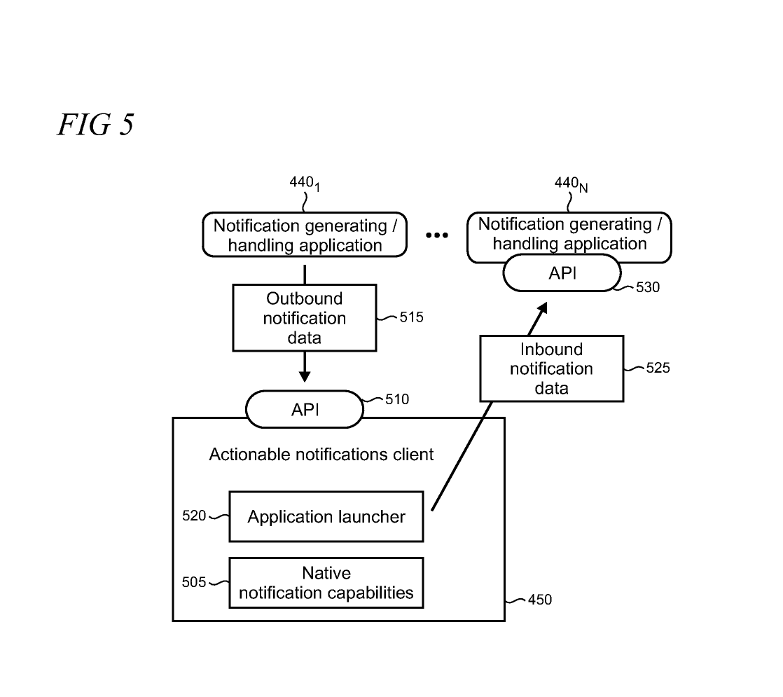

As shown in FIG. 5, the actionable notifications client 450 can support its own native notification capabilities 505 in some implementations, and typically in conjunction with the service 130. The actionable notifications client 450 may also expose an API 510 to one or more of the notification applications 440. The API 510 may enable a notification application 440 to interoperate with the actionable notifications service 130 in order to publish notifications to subscribing endpoints, as described in more detail below. The actionable notifications client 450 may support the API 510, in some cases, without also supporting its own native notifications capabilities. The API 510 is typically configured to expose various methods and functions to the notifications applications and receive outbound data 515 associated with a published notification (and exchange other signals and controls, etc.) as may be needed to implement a particular experience and/or feature.

The actionable notifications client 450 can include an application launcher 520 that can launch an appropriate application to support a native experience associated with a notification on a local endpoint 110 when a notification is received from a remote publishing endpoint. Typically, the client 450 will pass inbound notification data 525 to the application 440 through an API 530 as may be needed to render the native experience associated with the notification.

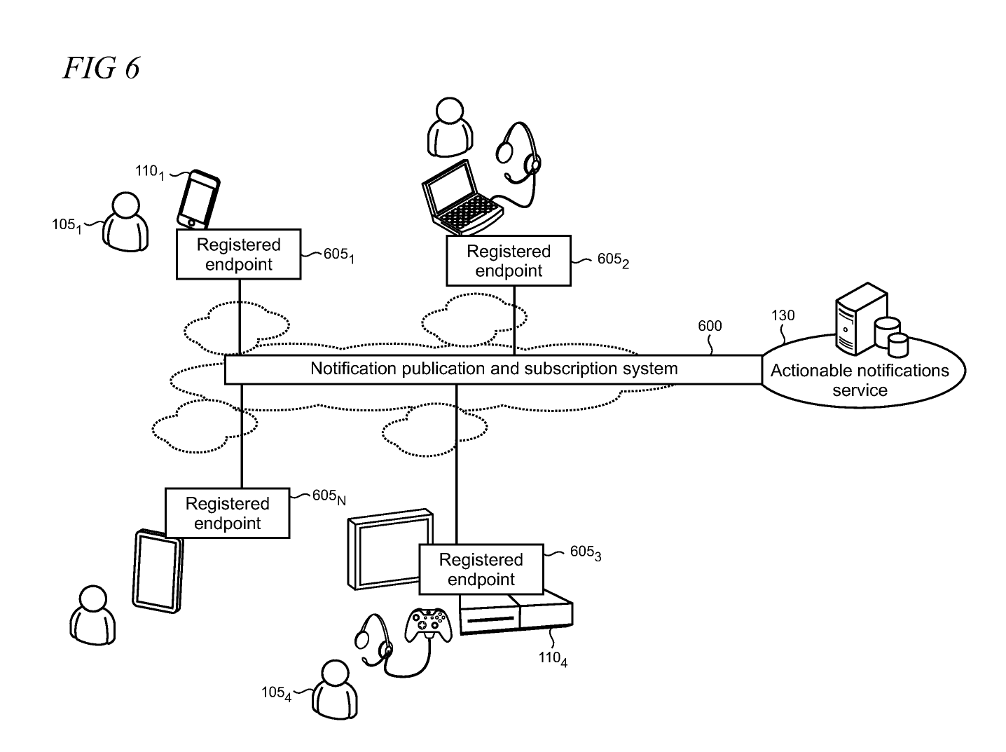

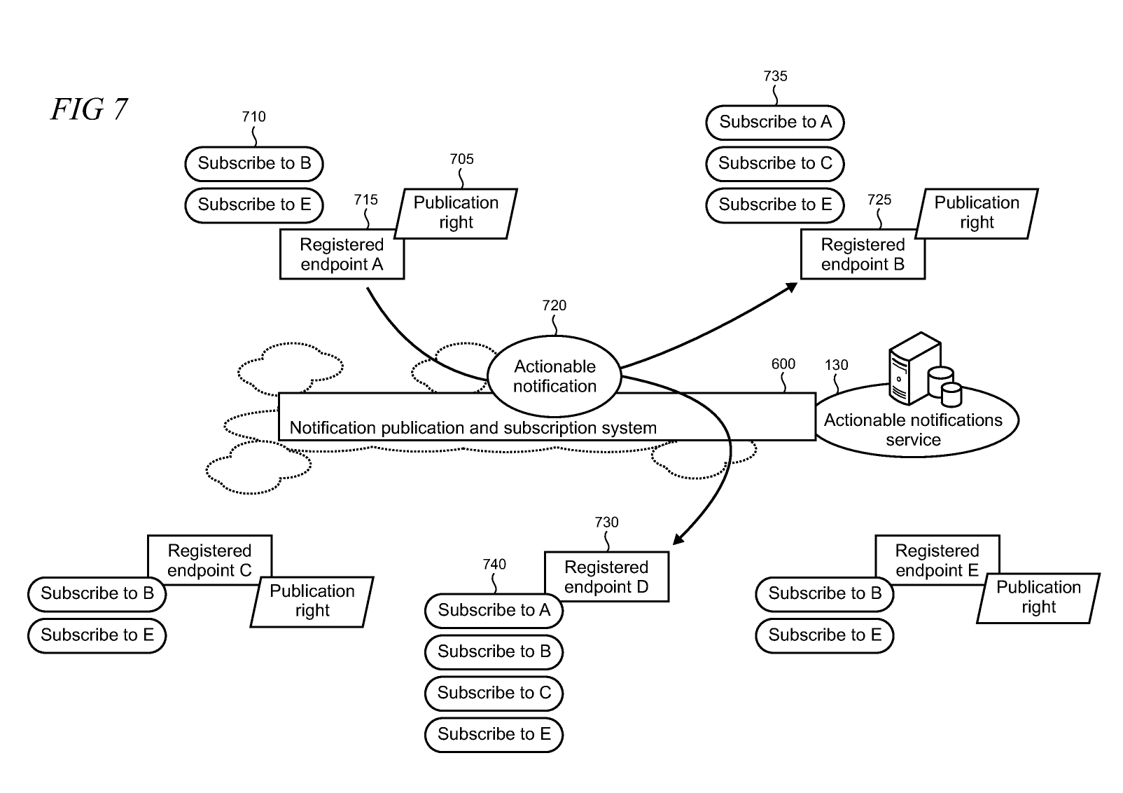

FIG. 6 shows a notification publication and subscription system 600 that is supported by the service 130. Endpoints register with the system 600 to become registered endpoints 605. As illustratively shown in FIG. 7, a registered endpoint can be registered for a right of publication (representatively indicated by reference numeral 705) as well as register as a subscriber (representatively indicated by reference numeral 710) to notifications published by other registered endpoints. An endpoint can support multiple user accounts which can be individually registered so that cross-domain notifications may be utilized in some cases.

In the example shown in FIG. 7, registered endpoint A 715 publishes an actionable notification 720 into the notification publication and subscription system 600. Registered endpoint B 725 and registered endpoint D 730 have registered as subscribers to actionable notifications published by registered endpoint A 715 (among other subscriptions) as respectively indicated by reference numerals 735 and 740 and receive the actionable notification 720 over the communications network.

As shown in FIG. 8, the actionable notification 720 can typically include content payload 805 that may be used by an application 440 (FIG. 4) to support a native experience as well as metadata 810 that can be used by the notification publication and subscription system 600 to route and/or filter actionable notifications to the relevant subscribing endpoints. In some implementations, the content payload 805 may be analyzed (in an anonymized manner) by the actionable notifications service to determine when notifications have the same content. For example, some or all of the content payloads may be subjected to hashing or other algorithms to enable notifications from different sources to be compared in order to verify uniqueness when identifying notifications to the subscribing endpoints. In addition, identical notifications can be eliminated by the system in some cases to enhance bandwidth and resource utilization. For example, a user may have multiple endpoints that receive the same weather and emergency notifications, etc., over cellular network connections. The user may prefer that identical notifications not be redundantly propagated by the actionable notifications service to each of the subscribing endpoints.

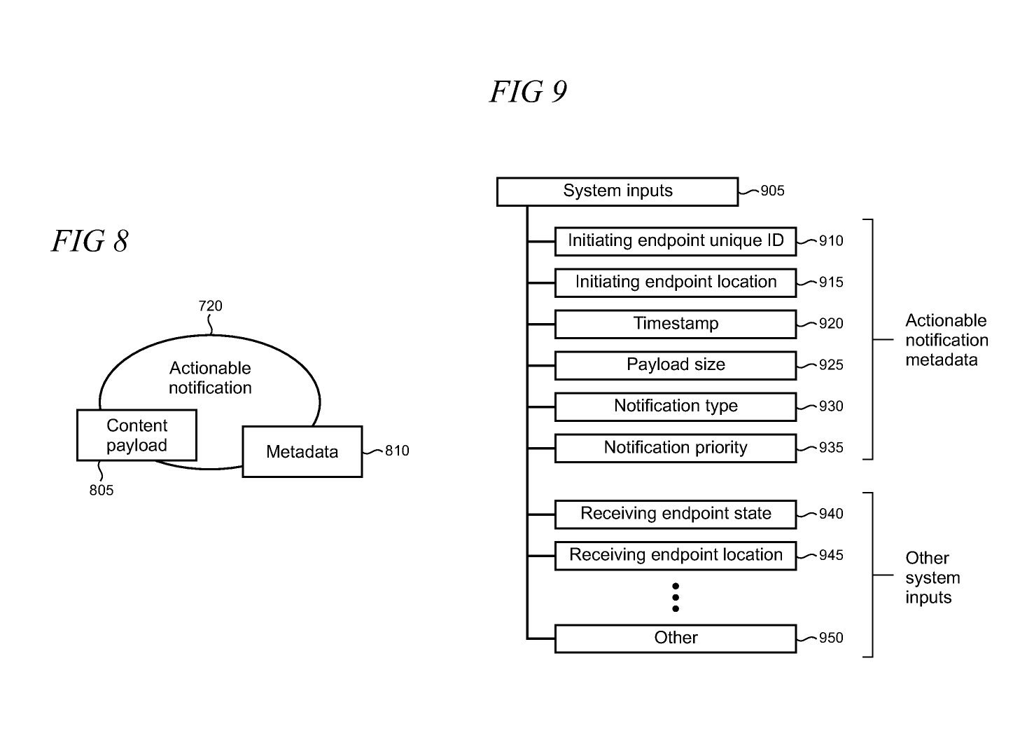

As shown in FIG. 9, the metadata provided in the actionable notification along with other data in some cases may be used as inputs 905 to the notification publication and subscription system 600. Not all of the illustrative inputs need to be used in every implementation of actionable notifications. The metadata can include an initiating endpoint unique identifier (ID) 910 that may facilitate the handling of duplicate notifications; the location 915 of the initiating endpoint; timestamp for the actionable notification 920; payload size 925; notification type 930 where types may include, for example, Action Required Dialogs (ARDs), alerts, emergency notifications, notification “toasts,” notification center items, etc.; and notification priority 935. Other system inputs may include receiving endpoint state 940 (e.g., amount of battery charge remaining, which access network is being utilized, etc.); receiving endpoint location 945; and other inputs 950 as may be needed for a particular actionable notification implementation.

The actionable notifications client 450 can surface a UI 1005 as shown in FIG. 10 to enable users to perform various tasks to set up actionable notifications that are tailored to their needs and manage endpoint and access network resources in an optimal manner. As shown, the UI 1005 can support controls for registering and unregistering endpoints with the notification publication and subscription system 1010; select publication rights for the applications 440 or the client 450 on the endpoints 1015; and manage subscriptions 1020 including setting acceptance criteria 1025 and suppression criteria 1030. In some implementations, the registration process can entail initially configuring an endpoint and then continuously provisioning the endpoint from the remote actionable notifications service as a privileged agent using what is typically referred to as a “bootstrapping” process.

The subscription management feature may facilitate users selecting criteria under which published notifications are received at a subscribing endpoint and criteria for suppressing notification receipt. For example, acceptance and suppression criteria can be specified through the UI 1005 so that notifications can be received at a subscribing endpoint during certain periods of the day and be suppressed at other times. In another example, criteria may be selected so that notifications may be accepted when a subscribing endpoint is on a Wi-Fi access network, but suppressed when on a cellular data access network, unless the notification is high priority. It is emphasized that these are just a few examples of how the subscription management feature may be utilized and that a variety of criteria may be specified using the system inputs 905 (FIG. 9) to tailor experiences and optimize resource allocation, utilization, and consumption to meet the needs of a given implementation.

The UI 1005 can also enable users to respond to notifications 1035 by actioning on notifications received at subscribing endpoints 1040 and dismiss notifications across multiple endpoints 1045 in order to manage and control duplicative notifications. Other features and functions 1050 can also be exposed by the UI 1005 as may be needed for specific implementations of actionable notifications. For example, the UI 1005 can be configured, in some cases, to provide users with a global view of all registered endpoints and details of their associated publication rights and subscriptions.

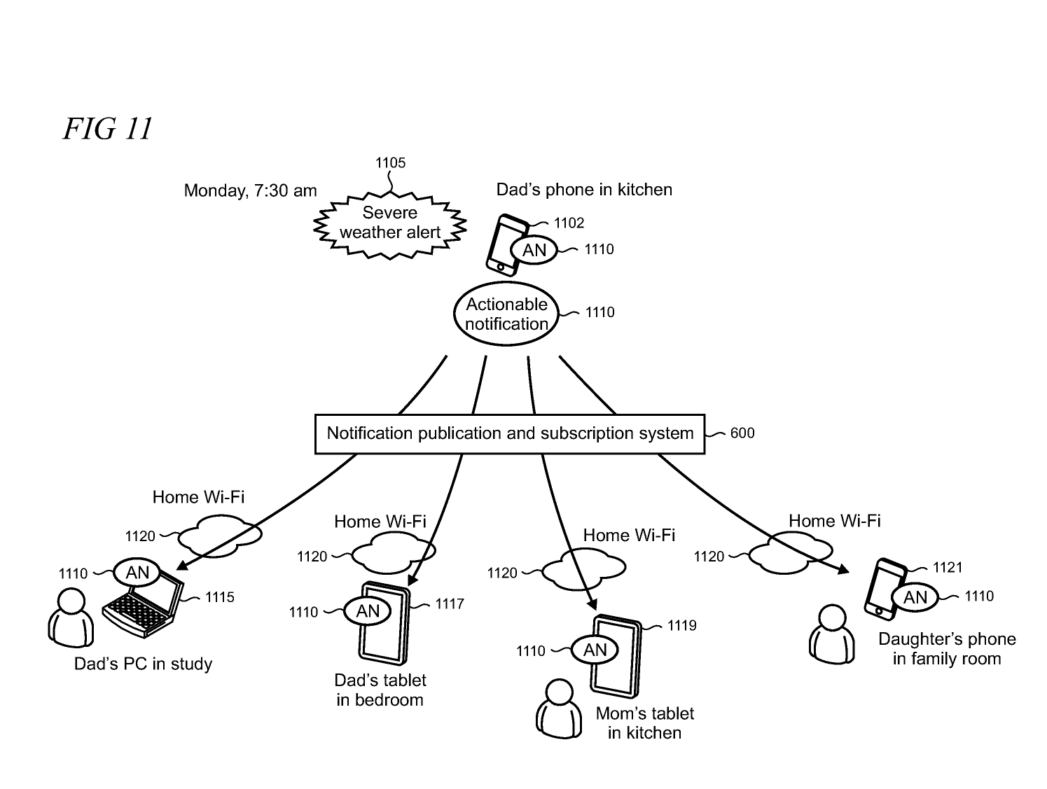

FIG. 11 shows an illustrative example of an actionable notification being shared among multiple subscribing endpoints. In this example, the dad's smartphone is a registered endpoint 1102 that is located in the kitchen. It receives a severe weather alert 1105 at 7:30 am on a Monday morning and publishes an actionable notification 1110 into the notification publication and subscription system 600. The system 600 surfaces the actionable notification 1110 on each of the subscribing endpoints 1115, 1117, 1119, and 1121 (which all belong to family members) that share a home Wi-Fi access network 1120 providing connectivity to the IP communications network 115 (FIG. 1). The actionable notification 1110 can also be surfaced by the system 600 on the originating endpoint 1102 to replace the incoming alert 1105 or supplement it with additional features or functionality in some cases.

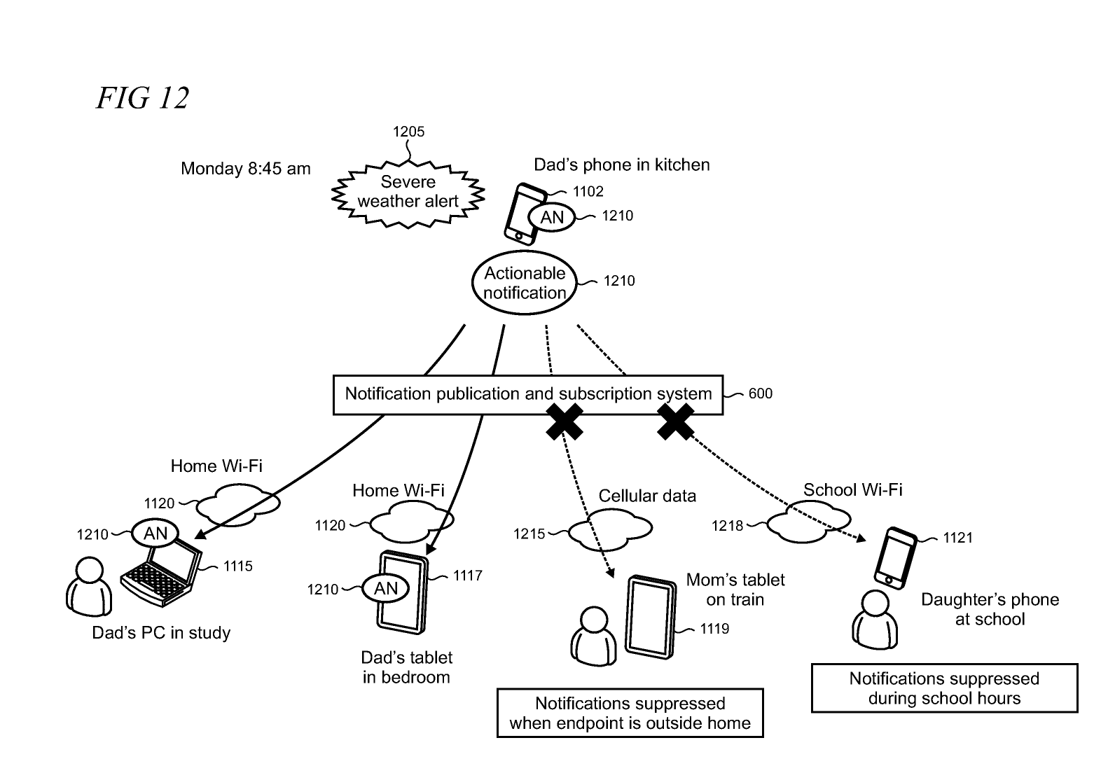

FIG. 12 shows a second severe weather alert 1205 being received at the originating endpoint 1102 later that morning at 8:45 am. At this time, some of the family members are no longer home—the mom is on a train heading to a meeting and the daughter is at school. The mom's endpoint (a tablet) has network connectivity using a cellular data access network 1215 and the daughter's endpoint (a smartphone) has connectivity through the school's Wi-Fi access network 1218.

The initiating endpoint 1102 publishes an actionable notification 1210 into the notification publication and subscription system 600. The system 600 surfaces the actionable notification 1210 on the subscribing endpoints 1115 and 1117 as with the earlier severe weather alert. As shown, the system 600 suppresses the actionable notifications on the subscribing endpoints 1119 and 1121. Criteria were selected, in this particular example, so that actionable notifications are suppressed when the mom's tablet is outside the home Wi-Fi network to reduce bandwidth consumption on the cellular data access network 1215. Criteria were also selected so that notifications are suppressed when the daughter's smartphone is located at school during classroom hours in order to comply with school policies to prevent distractions.

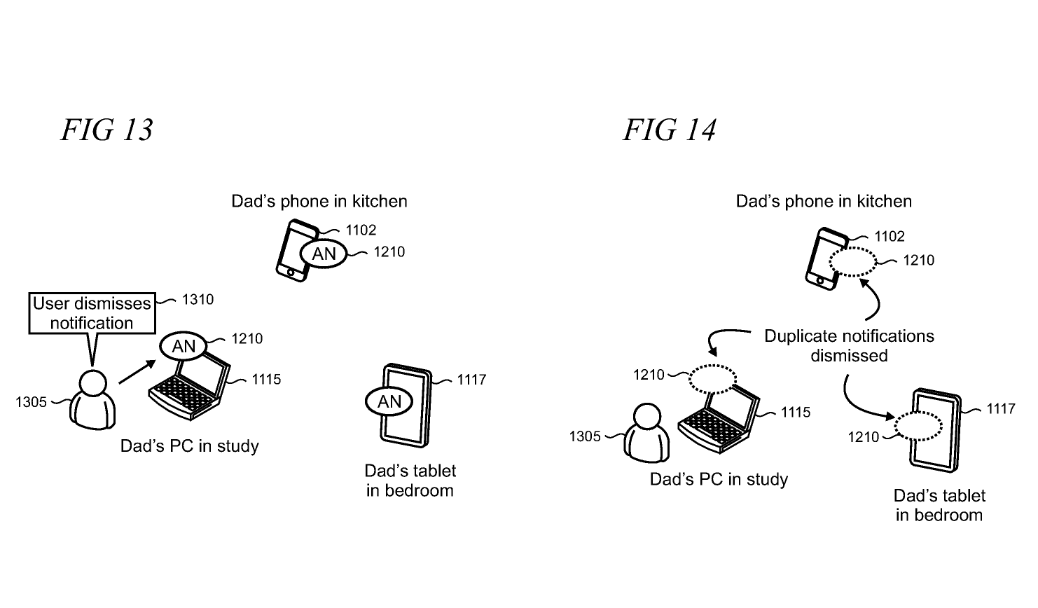

FIGS. 13 and 14 show actionable notifications being dismissed across multiple endpoints. Here, after the dad 1305 sees the actionable notification 1210 on the endpoint 1115 (a PC located in the study of the home), he can dismiss the actionable notification as indicated by reference numeral 1310. The actionable notification service can propagate the dismissal across the dad's other endpoints 1102 and 1117 (smartphone in kitchen and tablet in bedroom) so that duplicated notifications are dismissed, as shown in FIG. 14. Such synchronization of notification state across multiple endpoints can reduce user confusion as to whether a notification is new or has already been seen and handled and can also help manage resources across devices by eliminating the need for users to dismiss notifications at each of the endpoints.

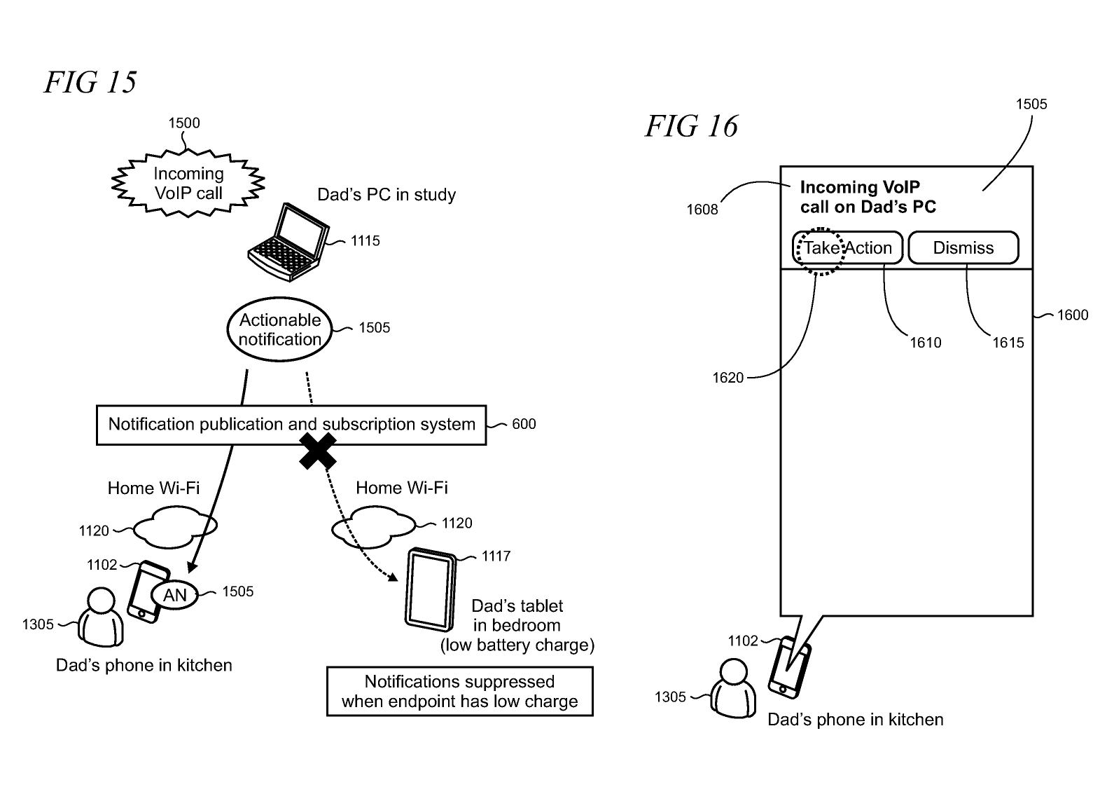

FIG. 15 shows an illustrative scenario in which an incoming VoIP (Voice over Internet Protocol) call 1500 is received at the dad's endpoint 1115. Responsively to the incoming call event, the endpoint 1102 initiates an actionable notification 1505 that is published into the system 600. The endpoints 1102 and 1117 are registered as subscribers to notifications published by endpoint 1115 so the actionable notification 1505 is surfaced on endpoint 1102. However as shown in FIG. 15, the endpoint 1117 is low on battery charge. In this particular example, the user has selected suppression criteria so that actionable notifications are suppressed when the state of a given endpoint device meets certain conditions such as the state of low battery charge for the tablet here.

FIG. 16 depicts a screen capture of an illustrative UI 1600 that is displayed on the endpoint 1102 which shows the surfaced actionable notification 1505 associated with the incoming VoIP call 1500. The actionable notification 1505 includes text 1608 to inform the user of the call event on another endpoint, a control 1610 for taking action, and a control 1615 to dismiss the notification. It is emphasized that the particular look and feel of the UIs shown here are intended to be illustrative and that variations may be utilized to meet the needs of a particular implementation of the present multi-endpoint actionable notifications. In addition, in the description that follows, user interaction with the UIs is discussed in the context of an endpoint that exposes a touch screen interface. However, it is noted that other types of inputs can also be utilized according to the features supported on a given endpoint such as physical or virtual button presses, gesture inputs into a gesture recognition device/software, voice commands, natural language inputs, etc. The particular user action that may be utilized for a given purpose can vary by implementation and endpoint.

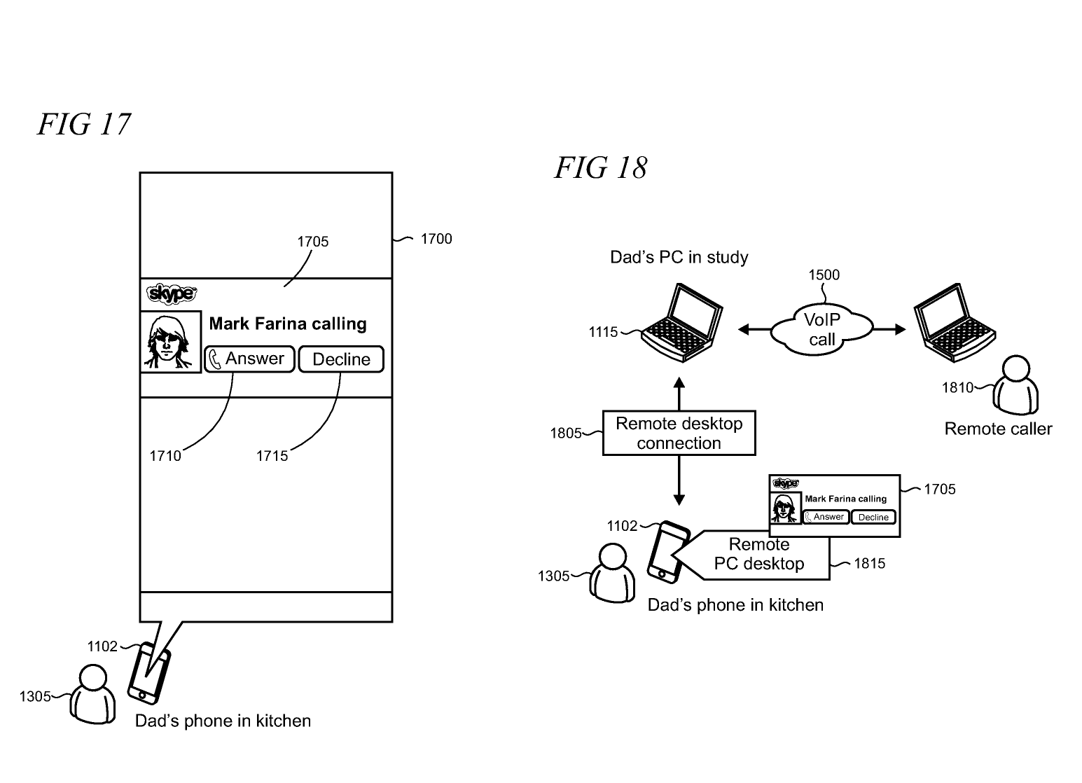

As shown in FIG. 16, the user (i.e., the dad) has employed a touch 1620 on the take action control 1610 to which the actionable notification service responds by interacting with the clients on the respective endpoints to surface the incoming VoIP call as shown on the UI 1700 displayed endpoint 1102 in FIG. 17. The UI 1700 includes a VoIP calling window 1705 that shows the caller along with a control 1710 to answer the call and a control 1715 to decline the call.

In typical implementations the calling window 1705 on the subscribing endpoint appears similarly to the window exposed by the native VoIP calling application on the initiating endpoint and the user can interact with the window 1705 to handle the call in a normal manner. Such operational transparency may be implemented in different ways according to the needs of a given implementation. As shown in FIG. 18, the endpoint 1102 can establish a remote desktop connection 1805 with the endpoint 1115 that is engaged in the VoIP call with the remote caller 1810. Over the remote connection, the endpoint 1102 can host a remote PC desktop 1815 and the VoIP calling window 1705.

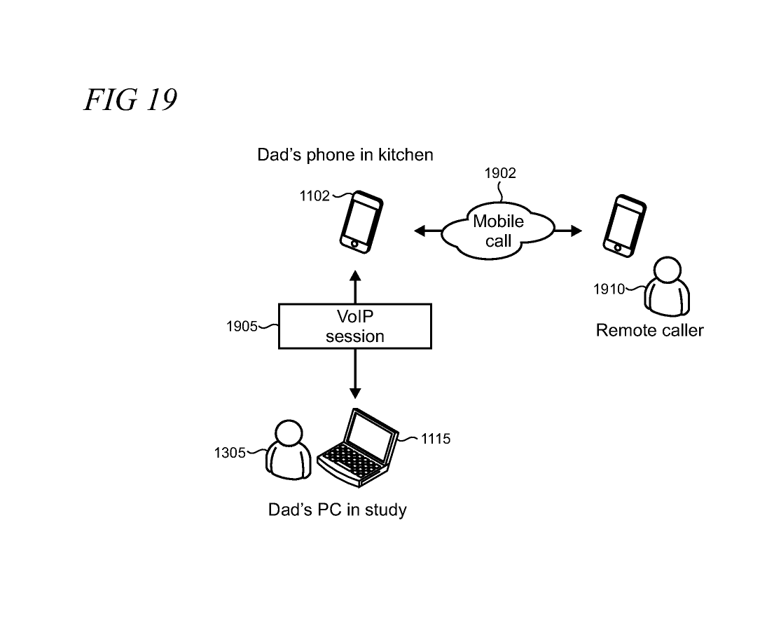

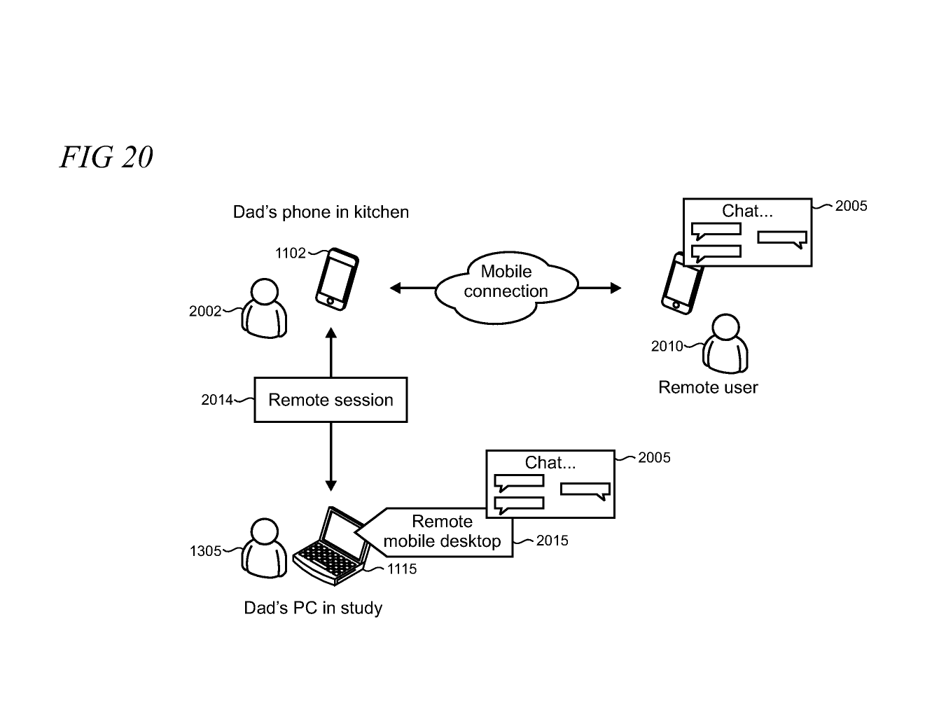

FIGS. 19 and 20 show other illustrative actionable notification scenarios. In FIG. 19, a remote caller 1910 makes a mobile call 1902 to the dad's endpoint 1102 in the kitchen. The endpoint can send an actionable notification to subscribing endpoints responsively to an incoming call event. The PC 1115 in the study, being a registered endpoint that is configured to receive notifications published by the endpoint 1102, can receive an actionable notification to set up a VoIP session 1905 that enables the user 1305 (i.e., the dad) to participate in the mobile call 1902 with the remote caller 1910 from the endpoint 1115.

In FIG. 20, a remote user 2010 initiates a chat session with the dad's endpoint 1102. When an incoming chat message is received, the endpoint 1102 responds to the event by sending an actionable notification to subscribing endpoints including the PC 1115. The actionable notification may be configured to enable a remote session 2014 to be established between the endpoints 1102 and 1115 so that a chat session 2005 can be hosted on a remote mobile desktop 2015. In this way, the user 1305 (i.e., the dad) can participate in the chat session 2005 with the remote user 2010 on the PC while another user 2002 uses the mobile phone endpoint 1102 for other purposes, such as playing games, listening to music, watching videos, etc.

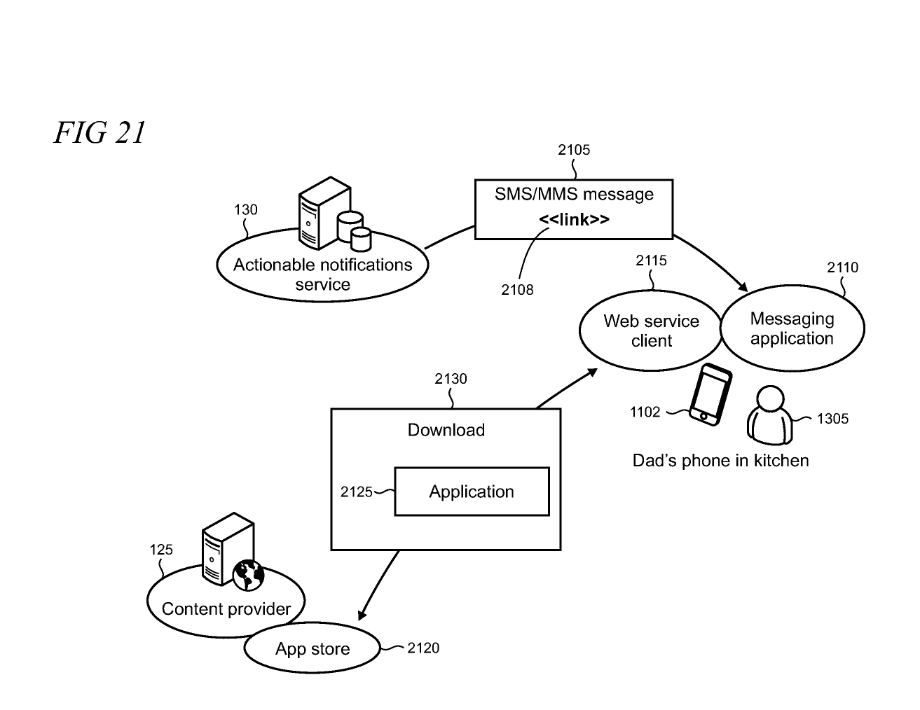

As shown in FIG. 21, the actionable notifications service 130 can send a notification 2105 such as an SMS or MMS (Multimedia Messaging Service) notification to a messaging application 2110 that executes on the endpoint 1102. The notification 2105 can include a link 2108 that can be followed, typically by a web service client 2115 such as a browser application to an application (app) store 2120 or similar service that can be exposed by the content provider 125. The app store 2120 can provide the appropriate application 2125 as a download 2130 so that the endpoint 1102 can handle the VoIP call directly rather than remotely.

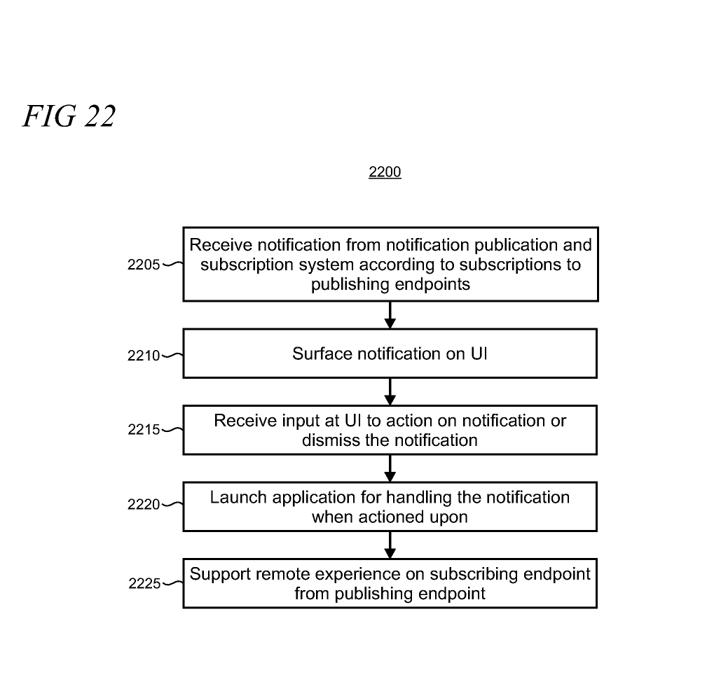

FIG. 22 shows a flowchart of an illustrative method 2200 for implementing multi-endpoint actionable notifications on an endpoint. Unless specifically stated, the methods or steps shown in the flowcharts below and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

In step 2205, an actionable notification is received at the endpoint from the notification publication and subscription system. As noted above, subscription criteria are user-selectable to enable user experiences and resources such as battery life and network utilization to be optimized to the user's needs. The received notification is surfaced on the subscribing endpoint's UI in step 2210. Input from the user at the UI is received in step 2215 to action on the notification or dismiss it. When a notification is dismissed, then duplicate notifications received at other subscribing endpoints are also dismissed by the actionable notifications service. When the notification is actioned upon through the UI, then in step 2220, the actionable notifications client can interact through an API with the relevant application on the endpoint to launch the application to handle the notification and provide the appropriate user experience. Alternatively, the service can facilitate a remote experience on the subscribing endpoint that is hosted by the initiating publishing endpoint in step 2225.

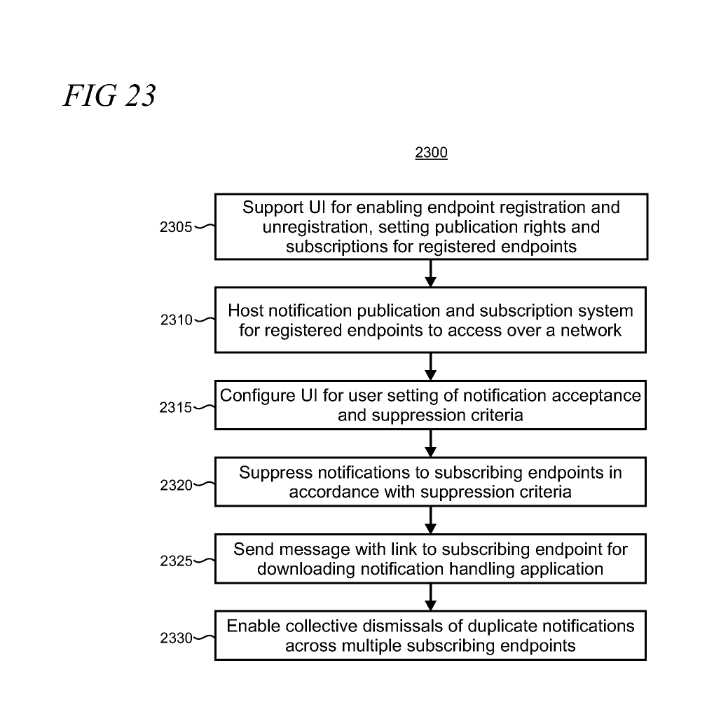

FIG. 23 shows a flowchart of an illustrative method 2300 for managing notification across multiple endpoints at the actionable notification service. In step 2305, the service exposes a UI that is configured for registering and unregistering endpoints with the system, and setting publication rights and subscriptions for registered endpoints. In step 2310, the service hosts the notification publication and subscription system that endpoints can access over the network so that published notifications can be distributed to subscribing endpoints. In step 2315, the service provides a UI that is configured for user setting of notification acceptance and suppression criteria and notifications are suppressed to subscribing endpoints in accordance with the suppression criteria in step 2320. In step 2325, the actionable notification service sends a notification to a subscribing endpoint that contains a link that can be followed to a remote resource to download a notification handling application. In step 2330, the actionable notification service enables collective dismissals of duplicated notifications across multiple subscribing endpoints when a user dismisses a notification at one of the subscribing endpoints.

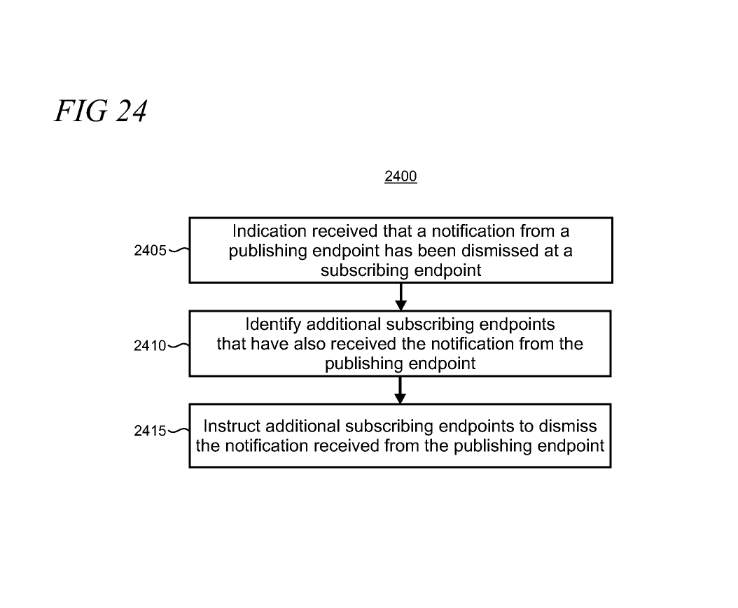

FIG. 24 shows a flowchart of an illustrative method 2400 for removing duplicate notifications across registered endpoints that can be implemented using a client-server arrangement. In step 2405, an indication is received that a notification from a publishing endpoint has been dismissed at a subscribing endpoint. In step 2410, additional subscribing endpoints that have also received the notification from the publishing endpoint are identified. The identification can include reviewing metadata associated with the published notification to verify that the notifications received at the additional subscribing endpoints are duplicative. In step 2415, the additional subscribing endpoints are instructed to dismiss the notification received from the publishing endpoint. Typically, the server can communicate with actionable notifications clients on respective endpoints to implement the dismissal across the endpoints.

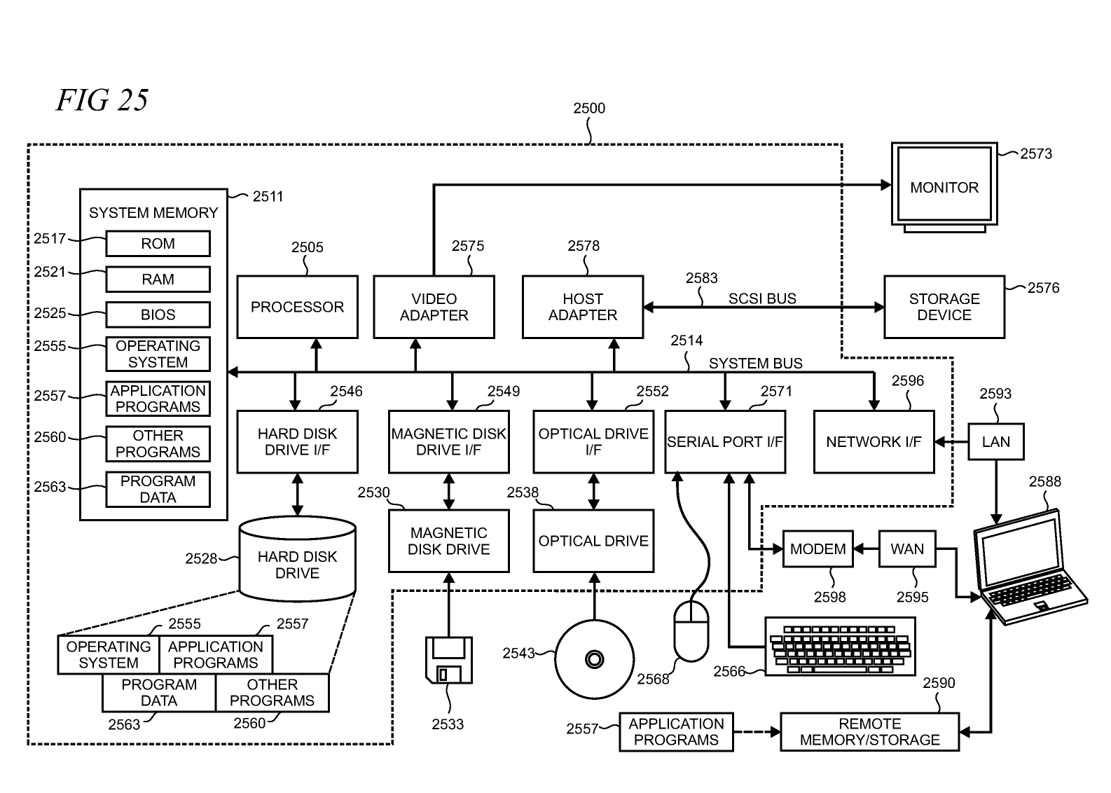

FIG. 25 is a simplified block diagram of an illustrative computer system 2500 such as a PC, client machine, or server with which the present multi-endpoint actionable notifications may be implemented. Computer system 2500 includes a processor 2505, a system memory 2511, and a system bus 2514 that couples various system components including the system memory 2511 to the processor 2505. The system bus 2514 may be any of several types of bus structures including a memory bus or memory controller, a peripheral bus, or a local bus using any of a variety of bus architectures. The system memory 2511 includes read only memory (ROM) 2517 and random access memory (RAM) 2521. A basic input/output system (BIOS) 2525, containing the basic routines that help to transfer information between elements within the computer system 2500, such as during startup, is stored in ROM 2517. The computer system 2500 may further include a hard disk drive 2528 for reading from and writing to an internally disposed hard disk (not shown), a magnetic disk drive 2530 for reading from or writing to a removable magnetic disk 2533 (e.g., a floppy disk), and an optical disk drive 2538 for reading from or writing to a removable optical disk 2543 such as a CD (compact disc), DVD (digital versatile disc), or other optical media. The hard disk drive 2528, magnetic disk drive 2530, and optical disk drive 2538 are connected to the system bus 2514 by a hard disk drive interface 2546, a magnetic disk drive interface 2549, and an optical drive interface 2552, respectively. The drives and their associated computer-readable storage media provide non-volatile storage of computer-readable instructions, data structures, program modules, and other data for the computer system 2500. Although this illustrative example includes a hard disk, a removable magnetic disk 2533, and a removable optical disk 2543, other types of computer-readable storage media which can store data that is accessible by a computer such as magnetic cassettes, Flash memory cards, digital video disks, data cartridges, random access memories (RAMs), read only memories (ROMs), and the like may also be used in some applications of the present multi-endpoint actionable notifications. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof, does not include waves, signals, and/or other transitory and/or intangible communication media.

A number of program modules may be stored on the hard disk, magnetic disk 2533, optical disk 2543, ROM 2517, or RAM 2521, including an operating system 2555, one or more application programs 2557, other program modules 2560, and program data 2563. A user may enter commands and information into the computer system 2500 through input devices such as a keyboard 2566 and pointing device 2568 such as a mouse. Other input devices (not shown) may include a microphone, joystick, game pad, satellite dish, scanner, trackball, touchpad, touch screen, touch-sensitive device, voice-command module or device, user motion or user gesture capture device, or the like. These and other input devices are often connected to the processor 2505 through a serial port interface 2571 that is coupled to the system bus 2514, but may be connected by other interfaces, such as a parallel port, game port, or universal serial bus (USB). A monitor 2573 or other type of display device is also connected to the system bus 2514 via an interface, such as a video adapter 2575. In addition to the monitor 2573, personal computers typically include other peripheral output devices (not shown), such as speakers and printers. The illustrative example shown in FIG. 25 also includes a host adapter 2578, a Small Computer System Interface (SCSI) bus 2583, and an external storage device 2576 connected to the SCSI bus 2583.

The computer system 2500 is operable in a networked environment using logical connections to one or more remote computers, such as a remote computer 2588. The remote computer 2588 may be selected as another personal computer, a server, a router, a network PC, a peer device, or other common network node, and typically includes many or all of the elements described above relative to the computer system 2500, although only a single representative remote memory/storage device 2590 is shown in FIG. 25. The logical connections depicted in FIG. 25 include a local area network (LAN) 2593 and a wide area network (WAN) 2595. Such networking environments are often deployed, for example, in offices, enterprise-wide computer networks, intranets, and the Internet.

When used in a LAN networking environment, the computer system 2500 is connected to the local area network 2593 through a network interface or adapter 2596. When used in a WAN networking environment, the computer system 2500 typically includes a broadband modem 2598, network gateway, or other means for establishing communications over the wide area network 2595, such as the Internet. The broadband modem 2598, which may be internal or external, is connected to the system bus 2514 via a serial port interface 2571. In a networked environment, program modules related to the computer system 2500, or portions thereof, may be stored in the remote memory storage device 2590. It is noted that the network connections shown in FIG. 25 are illustrative and other means of establishing a communications link between the computers may be used depending on the specific requirements of an application of the present multi-endpoint actionable notifications.

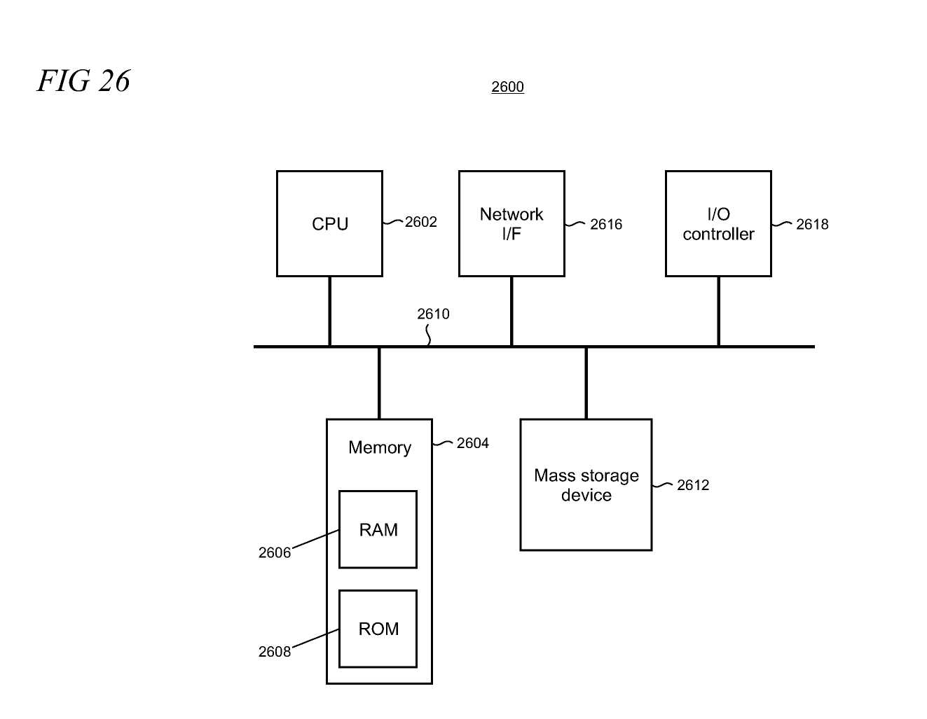

FIG. 26 shows an illustrative architecture 2600 for a device capable of executing the various components described herein for providing the present multi-endpoint actionable notifications. Thus, the architecture 2600 illustrated in FIG. 26 shows an architecture that may be adapted for a server computer, mobile phone, a PDA, a smartphone, a desktop computer, a netbook computer, a tablet computer, GPS device, gaming console, and/or a laptop computer. The architecture 2600 may be utilized to execute any aspect of the components presented herein.

The architecture 2600 illustrated in FIG. 26 includes a CPU (Central Processing Unit) 2602, a system memory 2604, including a RAM 2606 and a ROM 2608, and a system bus 2610 that couples the memory 2604 to the CPU 2602. A basic input/output system containing the basic routines that help to transfer information between elements within the architecture 2600, such as during startup, is stored in the ROM 2608. The architecture 2600 further includes a mass storage device 2612 for storing software code or other computer-executed code that is utilized to implement applications, the file system, and the operating system.

The mass storage device 2612 is connected to the CPU 2602 through a mass storage controller (not shown) connected to the bus 2610. The mass storage device 2612 and its associated computer-readable storage media provide non-volatile storage for the architecture 2600.

Although the description of computer-readable storage media contained herein refers to a mass storage device, such as a hard disk or CD-ROM drive, it may be appreciated by those skilled in the art that computer-readable storage media can be any available storage media that can be accessed by the architecture 2600.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 2600.

According to various embodiments, the architecture 2600 may operate in a networked environment using logical connections to remote computers through a network. The architecture 2600 may connect to the network through a network interface unit 2616 connected to the bus 2610. It may be appreciated that the network interface unit 2616 also may be utilized to connect to other types of networks and remote computer systems. The architecture 2600 also may include an input/output controller 2618 for receiving and processing input from a number of other devices, including a keyboard, mouse, or electronic stylus (not shown in FIG. 26). Similarly, the input/output controller 2618 may provide output to a display screen, a printer, or other type of output device (also not shown in FIG. 26).

It may be appreciated that the software components described herein may, when loaded into the CPU 2602 and executed, transform the CPU 2602 and the overall architecture 2600 from a general-purpose computing system into a special-purpose computing system customized to facilitate the functionality presented herein. The CPU 2602 may be constructed from any number of transistors or other discrete circuit elements, which may individually or collectively assume any number of states. More specifically, the CPU 2602 may operate as a finite-state machine, in response to executable instructions contained within the software modules disclosed herein. These computer-executable instructions may transform the CPU 2602 by specifying how the CPU 2602 transitions between states, thereby transforming the transistors or other discrete hardware elements constituting the CPU 2602.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 2600 in order to store and execute the software components presented herein. It may also be appreciated that the architecture 2600 may include other types of computing devices, including handheld computers, embedded computer systems, smartphones, PDAs, and other types of computing devices known to those skilled in the art. It is also contemplated that the architecture 2600 may not include all of the components shown in FIG. 26, may include other components that are not explicitly shown in FIG. 26, or may utilize an architecture completely different from that shown in FIG. 26.

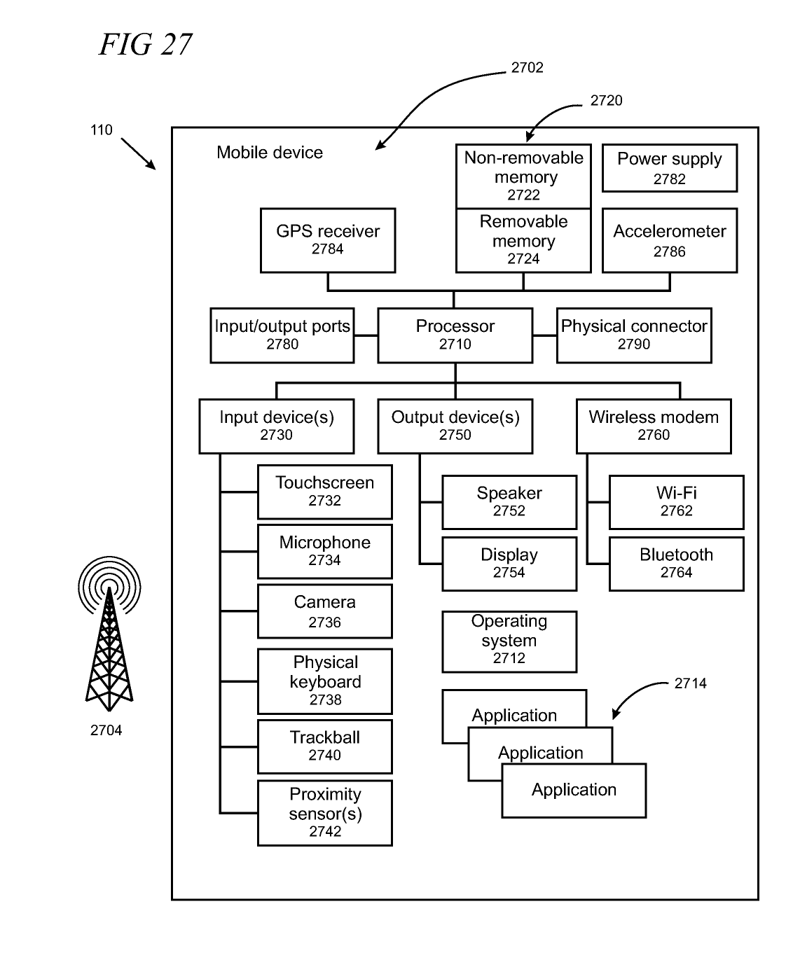

FIG. 27 is a functional block diagram of an illustrative mobile device 110 such as a mobile phone or smartphone including a variety of optional hardware and software components, shown generally at 2702. Any component 2702 in the mobile device can communicate with any other component, although, for ease of illustration, not all connections are shown. The mobile device can be any of a variety of computing devices (e.g., cell phone, smartphone, handheld computer, PDA, etc.) and can allow wireless two-way communications with one or more mobile communication networks 2704, such as a cellular or satellite network.

The illustrated device 110 can include a controller or processor 2710 (e.g., signal processor, microprocessor, microcontroller, ASIC (Application Specific Integrated Circuit), or other control and processing logic circuitry) for performing such tasks as signal coding, data processing, input/output processing, power control, and/or other functions. An operating system 2712 can control the allocation and usage of the components 2702, including power states, above-lock states, and below-lock states, and provides support for one or more application programs 2714. The application programs can include common mobile computing applications (e.g., image-capture applications, email applications, calendars, contact managers, web browsers, messaging applications), or any other computing application.

The illustrated mobile device 110 can include memory 2720. Memory 2720 can include non-removable memory 2722 and/or removable memory 2724. The non-removable memory 2722 can include RAM, ROM, Flash memory, a hard disk, or other well-known memory storage technologies. The removable memory 2724 can include Flash memory or a Subscriber Identity Module (SIM) card, which is well known in GSM (Global System for Mobile communications) systems, or other well-known memory storage technologies, such as “smart cards.” The memory 2720 can be used for storing data and/or code for running the operating system 2712 and the application programs 2714. Example data can include web pages, text, images, sound files, video data, or other data sets to be sent to and/or received from one or more network servers or other devices via one or more wired or wireless networks.

The memory 2720 may also be arranged as, or include, one or more computer-readable storage media implemented in any method or technology for storage of information such as computer-readable instructions, data structures, program modules or other data. For example, computer-readable media includes, but is not limited to, RAM, ROM, EPROM, EEPROM, Flash memory or other solid state memory technology, CD-ROM (compact-disc ROM), DVD, (Digital Versatile Disc) HD-DVD (High Definition DVD), Blu-ray, or other optical storage, magnetic cassettes, magnetic tape, magnetic disk storage or other magnetic storage devices, or any other medium which can be used to store the desired information and which can be accessed by the mobile device 110.

The memory 2720 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment. The mobile device 110 can support one or more input devices 2730; such as a touch screen 2732; microphone 2734 for implementation of voice input for voice recognition, voice commands and the like; camera 2736; physical keyboard 2738; trackball 2740; and/or proximity sensor 2742; and one or more output devices 2750, such as a speaker 2752 and one or more displays 2754. Other input devices (not shown) using gesture recognition may also be utilized in some cases. Other possible output devices (not shown) can include piezoelectric or haptic output devices. Some devices can serve more than one input/output function. For example, touchscreen 2732 and display 2754 can be combined into a single input/output device.

A wireless modem 2760 can be coupled to an antenna (not shown) and can support two-way communications between the processor 2710 and external devices, as is well understood in the art. The modem 2760 is shown generically and can include a cellular modem for communicating with the mobile communication network 2704 and/or other radio-based modems (e.g., Bluetooth 2764 or Wi-Fi 2762). The wireless modem 2760 is typically configured for communication with one or more cellular networks, such as a GSM network for data and voice communications within a single cellular network, between cellular networks, or between the mobile device and a public switched telephone network (PSTN).

The mobile device can further include at least one input/output port 2780, a power supply 2782, a satellite navigation system receiver 2784, such as a GPS receiver, an accelerometer 2786, a gyroscope (not shown), and/or a physical connector 2790, which can be a USB port, IEEE 1394 (FireWire) port, and/or an RS-232 port. The illustrated components 2702 are not required or all-inclusive, as any components can be deleted and other components can be added.

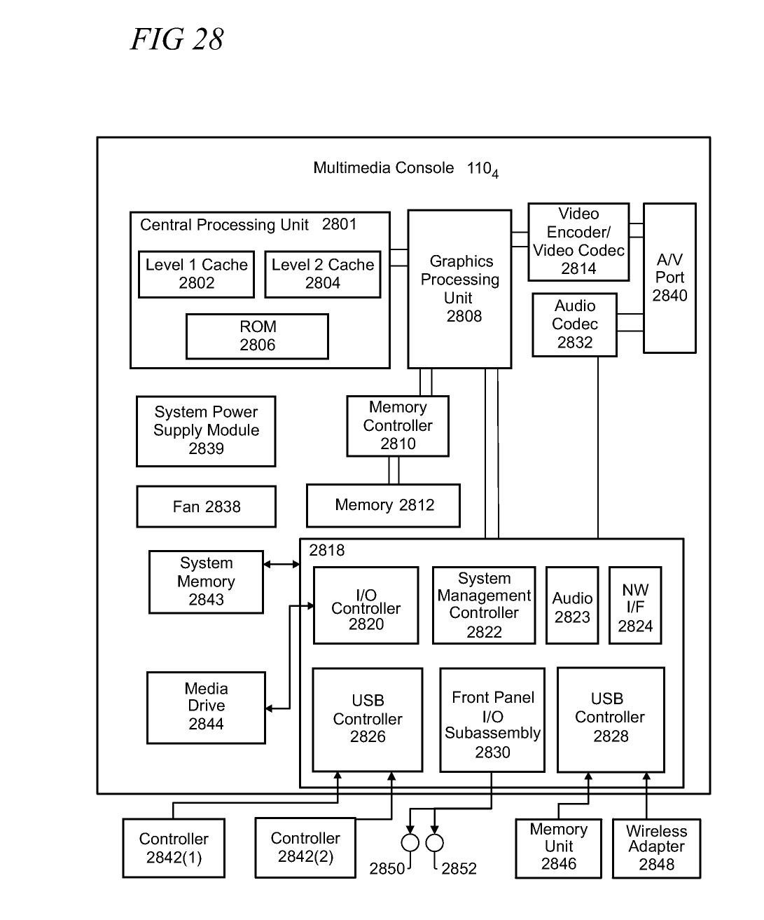

FIG. 28 is an illustrative functional block diagram of a multimedia console 110₄. The multimedia console 110₄ has a central processing unit (CPU) 2801 having a level 1 cache 2802, a level 2 cache 2804, and a Flash ROM (Read Only Memory) 2806. The level 1 cache 2802 and the level 2 cache 2804 temporarily store data and hence reduce the number of memory access cycles, thereby improving processing speed and throughput. The CPU 2801 may be configured with more than one core, and thus, additional level 1 and level 2 caches 2802 and 2804. The Flash ROM 2806 may store executable code that is loaded during an initial phase of a boot process when the multimedia console 110₄ is powered ON.

A graphics processing unit (GPU) 2808 and a video encoder/video codec (coder/decoder) 2814 form a video processing pipeline for high speed and high resolution graphics processing. Data is carried from the GPU 2808 to the video encoder/video codec 2814 via a bus. The video processing pipeline outputs data to an A/V (audio/video) port 2840 for transmission to a television or other display. A memory controller 2810 is connected to the GPU 2808 to facilitate processor access to various types of memory 2812, such as, but not limited to, a RAM.

The multimedia console 110₄ includes an I/O controller 2820, a system management controller 2822, an audio processing unit 2823, a network interface controller 2824, a first USB (Universal Serial Bus) host controller 2826, a second USB controller 2828, and a front panel I/O subassembly 2830 that are preferably implemented on a module 2818. The USB controllers 2826 and 2828 serve as hosts for peripheral controllers 2842(1) and 2842(2), a wireless adapter 2848, and an external memory device 2846 (e.g., Flash memory, external CD/DVD ROM drive, removable media, etc.). The network interface controller 2824 and/or wireless adapter 2848 provide access to a network (e.g., the Internet, home network, etc.) and may be any of a wide variety of various wired or wireless adapter components including an Ethernet card, a modem, a Bluetooth module, a cable modem, or the like.

System memory 2843 is provided to store application data that is loaded during the boot process. A media drive 2844 is provided and may comprise a DVD/CD drive, hard drive, or other removable media drive, etc. The media drive 2844 may be internal or external to the multimedia console 110₄. Application data may be accessed via the media drive 2844 for execution, playback, etc. by the multimedia console 110₄. The media drive 2844 is connected to the I/O controller 2820 via a bus, such as a Serial ATA bus or other high speed connection (e.g., IEEE 1394).

The system management controller 2822 provides a variety of service functions related to assuring availability of the multimedia console 110₄. The audio processing unit 2823 and an audio codec 2832 form a corresponding audio processing pipeline with high fidelity and stereo processing. Audio data is carried between the audio processing unit 2823 and the audio codec 2832 via a communication link. The audio processing pipeline outputs data to the A/V port 2840 for reproduction by an external audio player or device having audio capabilities.

The front panel I/O subassembly 2830 supports the functionality of the power button 2850 and the eject button 2852, as well as any LEDs (light emitting diodes) or other indicators exposed on the outer surface of the multimedia console 110₄. A system power supply module 2839 provides power to the components of the multimedia console 110₄. A fan 2838 cools the circuitry within the multimedia console 110₄.

The CPU 2801, GPU 2808, memory controller 2810, and various other components within the multimedia console 110₄ are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 110₄ is powered ON, application data may be loaded from the system memory 2843 into memory 2812 and/or caches 2802 and 2804 and executed on the CPU 2801. The application may present a graphical user interface that provides a consistent user experience when navigating to different media types available on the multimedia console 110₄. In operation, applications and/or other media contained within the media drive 2844 may be launched or played from the media drive 2844 to provide additional functionalities to the multimedia console 110₄.

The multimedia console 110₄ may be operated as a standalone system by simply connecting the system to a television or other display. In this standalone mode, the multimedia console 110₄ allows one or more users to interact with the system, watch movies, or listen to music. However, with the integration of broadband connectivity made available through the network interface controller 2824 or the wireless adapter 2848, the multimedia console 110₄ may further be operated as a participant in a larger network community.

When the multimedia console 110₄ is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbps), etc. Because these resources are reserved at system boot time, the reserved resources do not exist from the application's view.

In particular, the memory reservation preferably is large enough to contain the launch kernel, concurrent system applications, and drivers. The CPU reservation is preferably constant such that if the reserved CPU usage is not used by the system applications, an idle thread will consume any unused cycles.

With regard to the GPU reservation, lightweight messages generated by the system applications (e.g., pop-ups) are displayed by using a GPU interrupt to schedule code to render pop-ups into an overlay. The amount of memory needed for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV re-sync is eliminated.

After the multimedia console 110₄ boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 2801 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 2842(1) and 2842(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches.

Various exemplary embodiments of the present multi-endpoint actionable notifications are now presented by way of illustration and not as an exhaustive list of all embodiments. An example includes a device configured as a registered endpoint with a notification publication and subscription system, comprising: one or more processors; a display that supports a user interface (UI) for interacting with a device user; and a memory storing computer-readable instructions which, when executed by the one or more processors, perform a method for managing notifications across multiple endpoint devices, comprising: receiving a notification from the system according to subscriptions to publishing endpoints, the subscriptions being user-selectable for managing resources across the multiple endpoint devices, the resources including device resources and network resources, surfacing the received notification on the UI, receiving input at the UI to action on the notification or dismiss the notification, a dismissal of the notification at the UI causing dismissal of the notification respectively received at each of the other subscribing endpoints, and when the notification is actioned upon on the UI, launching an application for handling the notification.

In another example, the device further includes publishing a notification into the notification publication and subscription system, the notification being actionable when received and surfaced at subscribing endpoints. In another example, the device further includes hosting a client configured for interacting with the notification publication and subscription system, the client including at least one of launcher for launching the application handling the notification or native notification capabilities. In another example, the device further includes configuring the client to expose an application programming interface (API) to one or more applications, the API arranged to receive outbound notification data associated with notifications that are published into the notification publication and subscription system. In another example, the application is launched using a connection to a publishing endpoint to support a remote experience. In another example, each of the multiple endpoints uses respective access networks having different attributes for connectivity to the notification publication and subscription system and for notification transportation, and the managing includes managing utilization of the different access networks when transporting the notifications to respective multiple endpoints. In another example, the device further includes enabling a user at the UI to interact with the notification handling application as a native experience on the device. In another example, the device further includes configuring the UI for user interaction of one or more of endpoint registration, endpoint subscription management, or endpoint publication management, the endpoint subscription management including setting of criteria for notification acceptance or notification suppression. In another example, the criteria include one of endpoint location, time, notification characteristics, or endpoint state. In another example, the device is further incorporated into one of smartphone, tablet, wearable computing device, personal computer, or gaming device.

A further example includes a method for managing notifications across multiple endpoints, each endpoint being a device registered to a notification publication and subscription system, the method comprising the steps of: supporting a user interface (UI) exposed on a server, the user interface configured for i) enabling endpoints to be registered and unregistered with the notification publication and subscription system, ii) setting publication rights for registered endpoints, and iii) setting subscriptions for registered endpoints; and hosting the notification publication and subscription system for registered endpoints to access over a network, the notification publication and subscription system being arranged for distributing actionable notifications over the network between publishing endpoints and subscribing endpoints according to the publication rights and subscriptions.

In another example, the method further includes configuring the UI for user setting of notification acceptance and notification suppression criteria on a per-endpoint basis. In another example, the method further includes suppressing a notification from reaching an endpoint in accordance with the suppression criteria. In another example, the method further includes triggering establishment of a connection between a subscribing endpoint and a publishing endpoint to support a remote experience hosted on the publishing endpoint for the subscribing endpoint when a notification on the subscribing endpoint is actioned upon. In another example, the method further includes sending a notification with a link to a subscribing endpoint, the link, when followed, providing access to a notification handling application that is available for downloading by the subscribing endpoint. In another example, the method further includes dismissing duplicate notifications across remote endpoints in response to a user dismissing a notification at a local endpoint.

A further example includes one or more computer-readable memory devices storing instructions which, when executed by one or more processors in an electronic device, perform a method for removing duplicate notifications across endpoints being registered to a notification publication and subscription system, comprising: receiving an indication that a notification from a publishing endpoint received at a subscribing endpoint over a network has been dismissed; identifying additional subscribing endpoints that have received the notification from the publishing endpoint over the network; and instructing the additional subscribing endpoints to dismiss the notification received from the publishing endpoint.

In another example, the one or more computer-readable memory devices further include reviewing metadata associated with the notification to verify that the notifications received at the additional subscribing endpoints are duplicative. In another example, the metadata comprises a unique ID for the publishing endpoint. In another example, the notification publication and subscription system is implemented using a server that interoperates with clients disposed on respective registered endpoints.

Based on the foregoing, it may be appreciated that technologies for multi-endpoint actionable notifications have been disclosed herein. Although the subject matter presented herein has been described in language specific to computer structural features, methodological and transformative acts, specific computing machinery, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and may not be construed as limiting. Various modifications and changes may be made to the subject matter described herein without following the example embodiments and applications illustrated and described, and without departing from the true spirit and scope of the present invention, which is set forth in the following claims.

What is claimed:

1. A device configured as a registered endpoint with a notification publication and subscription system, comprising:
one or more processors;
a display that supports a user interface (UI) for interacting with a device user; and
a memory storing computer-readable instructions which, when executed by the one or more processors, perform a method for managing notifications across multiple endpoint devices, comprising:
receiving a notification from the system according to subscriptions to publishing endpoints, the subscriptions being user-selectable for managing resources across the multiple endpoint devices, the resources including device resources and network resources,
surfacing the received notification on the UI,
receiving input at the UI to action on the notification or dismiss the notification, a dismissal of the notification at the UI causing dismissal of the notification respectively received at each of the other subscribing endpoints, and
when the notification is actioned upon on the UI, launching an application for handling the notification.

2. The device of claim 1 further including publishing a notification into the notification publication and subscription system, the notification being actionable when received and surfaced at subscribing endpoints.

3. The device of claim 1 further including hosting a client configured for interacting with the notification publication and subscription system, the client including at least one of launcher for launching the application handling the notification or native notification capabilities.

4. The device of claim 3 further including configuring the client to expose an application programming interface (API) to one or more applications, the API arranged to receive outbound notification data associated with notifications that are published into the notification publication and subscription system.

5. The device of claim 1 in which the application is launched using a connection to a publishing endpoint to support a remote experience.

6. The device of claim 1 in which each of the multiple endpoints uses respective access networks having different attributes for connectivity to the notification publication and subscription system and for notification transportation, and in which the managing includes managing utilization of the different access networks when transporting the notifications to respective multiple endpoints.

7. The device of claim 1 further including enabling a user at the UI to interact with the notification handling application as a native experience on the device.

8. The device of claim 1 further including configuring the UI for user interaction of one or more of endpoint registration, endpoint subscription management, or endpoint publication management, the endpoint subscription management including setting of criteria for notification acceptance or notification suppression.

9. The device of claim 8 in which the criteria include one of endpoint location, time, notification characteristics, or endpoint state.

10. The device of claim 1 further being incorporated into one of smartphone, tablet, wearable computing device, personal computer, or gaming device.

11. A method for managing notifications across multiple endpoints, each endpoint being a device registered to a notification publication and subscription system, the method comprising the steps of:
supporting a user interface (UI) exposed on a server, the user interface configured for i) enabling endpoints to be registered and unregistered with the notification publication and subscription system, ii) setting publication rights for registered endpoints, and iii) setting subscriptions for registered endpoints; and
hosting the notification publication and subscription system for registered endpoints to access over a network, the notification publication and subscription system being arranged for distributing actionable notifications over the network between publishing endpoints and subscribing endpoints according to the publication rights and subscriptions.

12. The method of claim 11 further including configuring the UI for user setting of notification acceptance and notification suppression criteria on a per-endpoint basis.

13. The method of claim 12 further including suppressing a notification from reaching an endpoint in accordance with the suppression criteria.

14. The method of claim 11 further including triggering establishment of a connection between a subscribing endpoint and a publishing endpoint to support a remote experience hosted on the publishing endpoint for the subscribing endpoint when a notification on the subscribing endpoint is actioned upon.

15. The method of claim 11 further including sending a notification with a link to a subscribing endpoint, the link, when followed, providing access to a notification handling application that is available for downloading by the subscribing endpoint.

16. The method of claim 11 further including dismissing duplicate notifications across remote endpoints in response to a user dismissing a notification at a local endpoint.

17. One or more computer-readable memory devices storing instructions which, when executed by one or more processors in an electronic device, perform a method for removing duplicate notifications across endpoints being registered to a notification publication and subscription system, comprising:
receiving an indication that a notification from a publishing endpoint received at a subscribing endpoint over a network has been dismissed;
identifying additional subscribing endpoints that have received the notification from the publishing endpoint over the network; and
instructing the additional subscribing endpoints to dismiss the notification received from the publishing endpoint.

18. The one or more computer-readable memory devices of claim 17 further including reviewing metadata associated with the notification to verify that the notifications received at the additional subscribing endpoints are duplicative.

19. The one or more computer-readable memory devices of claim 18 in which the metadata comprises a unique ID for the publishing endpoint.

20. The one or more computer-readable memory devices of claim 17 in which the notification publication and subscription system is implemented using a server that interoperates with clients disposed on respective registered endpoints.
